(19) United States
(12) Patent Application Publication
(10) Pub. No.: US 2016/0124353 A1
(43) Pub. Date: May 5, 2016

(54) IMAGE FORMING APPARATUS

(71) Applicant: CANON KABUSHIKI KAISHA, Tokyo (JP)

(72) Inventor: Tohru Nakaegawa, Nagareyama-shi (JP)

(21) Appl. No.: 14/918,917

(22) Filed: Oct. 21, 2015

(30) Foreign Application Priority Data
Nov. 5, 2014 (JP) 2014-225646

(51) Int. Cl. G03G 15/16

(52) U.S. Cl. CPC G03G 15/1665

(57) ABSTRACT

An image forming apparatus includes a photosensitive member, a charging member for electrically charging the photosensitive member to a first polarity, an intermediary transfer belt, a transfer member, a constant-voltage element, a voltage source, and a controller for executing an adjusting operation for applying at least a voltage of a second polarity, opposite to the first polarity from the voltage source to the transfer member during non-image formation in which both of primary transfer and secondary transfer are not effected. When the voltage of the second polarity is applied from the voltage source to the transfer member in the adjusting operation, the controller continuously applies the voltage for a time corresponding to a substantially integer multiple of a time required for one full turn of the photosensitive member.

### FIELD OF THE INVENTION AND RELATED ART

The present invention relates to an image forming apparatus, such as a copying machine or a printer, of an electrophotographic type.

As a conventional image forming apparatus of an electrophotographic type, there is an image forming apparatus employing an intermediary transfer type in which a toner image formed on a photosensitive member is primary-transferred onto an intermediary transfer member and then is secondary-transferred onto a transfer material such as paper. As the image forming apparatus of the intermediary transfer type, there is an image forming apparatus of a type which is called a tandem type in which a plurality of image forming portions for forming toner images of different colors are independently provided and the toner images are successively primary-transferred from the respective image forming portions onto the intermediary transfer member and then are collectively secondary-transferred from the intermediary transfer member onto the transfer material. In general, as the photosensitive member, a drum-shaped photosensitive drum is used, and as the intermediary transfer member, an endless belt-shaped intermediary transfer belt is used.

At each of the image forming portions of the tandem-type image forming apparatus employing the intermediary transfer type, a surface of a rotating photosensitive drum is electrically charged uniformly to a predetermined polarity and a predetermined potential, and then the charged surface of the photosensitive drum is exposed to light, so that an electrostatic latent image is formed on the photosensitive drum. The electrostatic latent image formed on the photosensitive drum is supplied with a toner and thus is developed (visualized) as a toner image. The toner image formed on the photosensitive drum is primary-transferred from the photosensitive drum onto an intermediary transfer belt (member) by a primary transfer member provided opposed to the photosensitive drum via the intermediary transfer belt. As the primary transfer member, a primary transfer roller having a roller shape is used in general, and this primary transfer roller is urged toward the photosensitive drum via the intermediary transfer belt. To the primary transfer roller at each of the image forming portions, a voltage source (high-voltage source) exclusively for primary transfer is connected and a predetermined primary transfer voltage is applied.

On the other hand, the toner image formed on the intermediary transfer belt is secondary-transferred from the intermediary transfer belt onto the transfer material by a secondary transfer member provided in contact with intermediary transfer belt. As the secondary transfer member, a secondary transfer roller is used in general, and this secondary transfer roller is urged toward one of stretching rollers for the intermediary transfer belt via the intermediary transfer belt. To the secondary transfer roller, a voltage source (high-voltage source) exclusively for secondary transfer is connected and a predetermined secondary transfer voltage is applied.

However, such an image forming apparatus, primary transfer steps from a plurality of photosensitive drums onto the intermediary transfer belt progress in parallel, and therefore there was a need to independently provide the voltage source exclusively for primary transfer using each of the primary transfer rollers. For that reason, due to many voltage sources, an increase in cost and upsizing of the image forming apparatus have been invited. Further, due to agglomeration of the toner by local pressure application to the toner at the primary transfer portion, a hollow image including a part of the image which is not transferred and a transfer dropout image appearing at the secondary transfer portion generated in some cases.

Therefore, Japanese Laid-Open Patent Application 2006-259640 discloses a constitution in which a primary transfer roller is omitted and a degree of toner agglomeration generated due to local transfer pressure at a primary transfer portion is alleviated.

Japanese Laid-Open Patent Application 2012-137733 discloses a constitution in which both of primary transfer and secondary transfer are effected by causing a current to flow from a secondary transfer portion to an intermediary transfer belt with respect to a circumferential direction. In this case, an electroconductive endless belt capable of causing the current to flow through the belt with respect to the circumferential direction is used as the intermediary transfer belt, and stretching rollers for this belt are grounded via a passive element such as a resistance element, a varistor or Zener diode, and then a current is caused to flow through the belt by applying a voltage to a secondary transfer member.

That is, by grounding all of the stretching rollers via the passive element described above, it is possible to prevent a primary transfer current to uselessly flow through the stretching rollers. In addition, by using the intermediary transfer belt at least including a low-resistant layer, it is possible to cause a high voltage applied to the secondary transfer roller via the intermediary transfer belt to act on the primary transfer portion. For example, in the case where all of the stretching rollers are grounded via the Zener diode, by applying a voltage having a certain value or more to the secondary transfer roller, a potential of the intermediary transfer belt is maintained at an arbitrary Zener voltage (breakdown voltage). Further, by applying the voltage to the secondary transfer roller, a current flows to the photosensitive drum of each of the image forming portions via the intermediary transfer belt, thus having the same function as a conventional primary transfer portion.

However, in a system from which the above-described voltage source exclusively for the primary transfer, in the case where an adjusting operation during non-image formation performed in a conventional image forming apparatus in which such a system is not used is adopted, it was turned out that the following problem arose.

That is, as one of conventional adjusting operations performed during non-image formation, a cleaning operation for collecting the toner deposited on the secondary transfer roller by transferring the toner from the secondary transfer roller onto the intermediary transfer belt, for example, every predetermined image output sheet number or after clearance of jam (paper jam) is performed in some cases. FIG. 10 is a timing chart showing timing of a charging voltage (in the form of a DC voltage biased with an AC voltage) in the cleaning operation in the conventional image forming apparatus including the voltage source exclusively for the primary transfer. In this case, description will be made by taking, as an example, a constitution in which a charge polarity of the photosensitive drum is negative and the toner image is formed by image portion exposure and reverse development. In the conventional image forming apparatus, a constitution in which the current does not interfere between the primary transfer portion and the secondary transfer portion is employed. For that reason, it is possible to separately consider positive polarity voltage application to the secondary transfer roller and charging voltage application from each other. In the cleaning operation, the positive polarity voltage and a negative polarity voltage are alternately applied to the secondary transfer roller, so that a positive polarity drum toner and a negative polarity toner which are deposited on the secondary transfer roller are transferred and collected onto the intermediary transfer belt. In this case, in the conventional constitution, an application time of each of the positive polarity voltage and the negative polarity voltage is a time (required for movement of the surface of the secondary transfer roller by a distance which is an integer multiple of a circumferential length of the secondary transfer roller) corresponding to an integer multiple of a time required for one full turn of the secondary transfer roller.

On the other hand, in the system from which the voltage source exclusively for the primary transfer as described above, a constitution in which the current is caused to flow through the photosensitive drum by applying the positive polarity voltage to the secondary transfer roller is employed. For that reason, when the positive polarity voltage is applied to the secondary transfer roller also during the cleaning operation of the secondary transfer roller, a surface potential of the intermediary transfer belt is maintained at a certain potential. As a result, when a high voltage of the positive polarity is applied to the secondary transfer roller in the cleaning operation, the photosensitive drum is influenced by an electric discharge current via the intermediary transfer belt. At this time, depending on the voltage application time to the secondary transfer roller in the cleaning operation, the surface potential of the intermediary transfer belt changes within a range of a circumferential length of the photosensitive drum, so that the influence of an electric discharge current on the photosensitive drum is different with respect to the photosensitive drum. As a result, there is a liability that the surface potential of the photosensitive drum cannot be uniformized by a charging process during subsequent image formation to cause potential non-uniformity and thus image density non-uniformity (hereinafter also referred to as a drum memory) locally generates.

As described above, in the cleaning operation, each of the positive polarity voltage and the negative polarity voltage is alternately applied to the secondary transfer roller for the time corresponding to the integer multiple of the circumferential length of the secondary transfer roller, and the circumferential length of the secondary transfer roller is shorter than the circumferential length of the photosensitive drum in general. In this case, as described above, the influence of the discharge current on the photosensitive drum in the cleaning operation is different with respect to the circumferential direction, so that there is a liability that the drum memory generates with respect to a sub-scan direction corresponding to the circumferential direction of the photosensitive drum. Particularly, as shown in FIG. 10, in the case where no charging voltage is applied in the cleaning operation, the surface potential of the photosensitive drum is locally reversed in polarity opposite to the charge polarity of the photosensitive drum by the influence of the positive polarity surface potential of the intermediary transfer belt, so that the drum memory is liable to generate. Further, the photosensitive drum caused the drum memory requires exchange in some cases, and therefore a problem can arise also in terms of a running cost and downtime (period in which the image cannot be outputted).

In the above, the case where the adjusting operation is the cleaning operation of the secondary transfer roller was described as an example, but a similar problem can occur in any operation in the case where the voltage of the opposite polarity to the charge polarity of the photosensitive drum is applied to the secondary transfer roller during non-image formation.

### SUMMARY OF THE INVENTION

A principal object of the present invention is to provide an image forming apparatus in which in a constitution in which primary transfer is effected by causing a current to flow through a photosensitive member via an intermediary transfer belt under application of a secondary transfer voltage, it is possible to suppress generation of potential non-uniformity of a photosensitive member due to the influence of a voltage applied to a secondary transfer portion in an adjusting operation.

According to an aspect of the present invention, there is provided an image forming apparatus comprising: a photosensitive member for carrying a toner image; a charging member for electrically charging the photosensitive member to a first polarity; an intermediary transfer belt for carrying the toner image transferred from the photosensitive member at a first transfer position; a transfer member, provided so as to be contactable to an outer peripheral surface of the intermediary transfer belt, for transferring the toner image from the intermediary transfer belt onto a recording material at a secondary transfer position; a constant-voltage element, electrically connected between the intermediary transfer belt and a ground potential, for maintaining a predetermined voltage by a flow of a current therethrough; a voltage source for applying a voltage of a second polarity opposite to the first polarity to the transfer member so as to form a secondary transfer electric field at the secondary transfer position and a primary transfer electric field at the primary transfer position; and a controller for executing an adjusting operation for applying at least the voltage of the second polarity from the voltage source to the transfer member during non-image formation in which both of primary transfer and secondary transfer are not effected, wherein when the voltage of the second polarity is applied from the voltage source to the transfer member in the adjusting operation, the controller continuously applies the voltage for a time corresponding to a substantially integer multiple of a time required for one full turn of the photosensitive member.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an image forming apparatus.

FIG. 2 is a graph showing a voltage-current (VI) characteristic of the ZD.

In FIG. 3, (a) and (b) are schematic views showing an adjusting method of a transfer contrast.

FIG. 4 is a block diagram showing a control mode of a principal part of the image forming apparatus.

FIG. 5 is a timing chart of a cleaning operation of a secondary transfer roller.

FIG. 6 is a schematic sectional view of an image forming apparatus in another embodiment.

FIG. 7 is a block diagram showing a control mode of a principal part of the image forming apparatus in another embodiment.

FIG. 8 is a graph for illustrating ATVC at a secondary transfer portion.

FIG. 9 is a timing chart of the ATVC at the secondary transfer portion.

FIG. 10 is a timing chart of a cleaning operation of a secondary transfer roller in a conventional image forming apparatus.

FIG. 11 is a timing chart of ATVC at a secondary transfer portion in the conventional image forming apparatus.

FIG. 12 is a schematic sectional view of the conventional image forming apparatus.

### DESCRIPTION OF THE EMBODIMENTS

An image forming apparatus according to the present invention will be described with reference to the drawings.

### Embodiment 1

### 1. General Constitution and Operation of Image Forming Apparatus

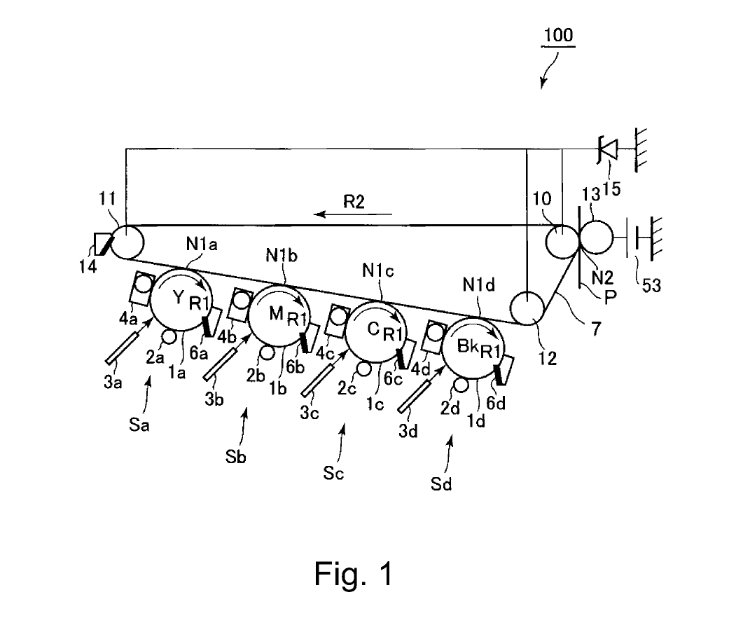

FIG. 1 is a schematic sectional view of an image forming apparatus 100 in this embodiment according to the present invention.

The image forming apparatus 100 in this embodiment is a tandem laser beam printer capable of outputting a full-color image using an electrophotographic type and an intermediary transfer type.

The image forming apparatus 100 includes, as a plurality of image forming portions, first to fourth image forming portions (stations) Sa, Sb, Sc and Sd for forming images of yellow (Y), magenta (M), cyan (C) and black (Bk), respectively. These image forming portions are disposed in line with intervals. In this embodiment, constitutions and operations of the image forming portions Sa, Sb, Sc and Sd are substantially the same except that the colors of toners used are different from each other. Accordingly, in the following, in the case where particular distinction is not required, suffixes a, b, c and D for representing elements for associated colors are omitted, and the elements will be collectively described.

At the image forming portion S, a photosensitive drum 1 which is a rotatable drum-shaped (cylindrical) electrophotographic photosensitive member as an image bearing member is provided. In this embodiment, the photosensitive drum 1 is a negatively chargeable organic photosensitive member including a drum support of aluminum or the like and a photosensitive layer formed on the drum support and is 30 mm in outer diameter. The photosensitive drum 1 is rotationally driven in an indicated arrow R1 direction at a predetermined peripheral speed (process speed) by an unshown driving means.

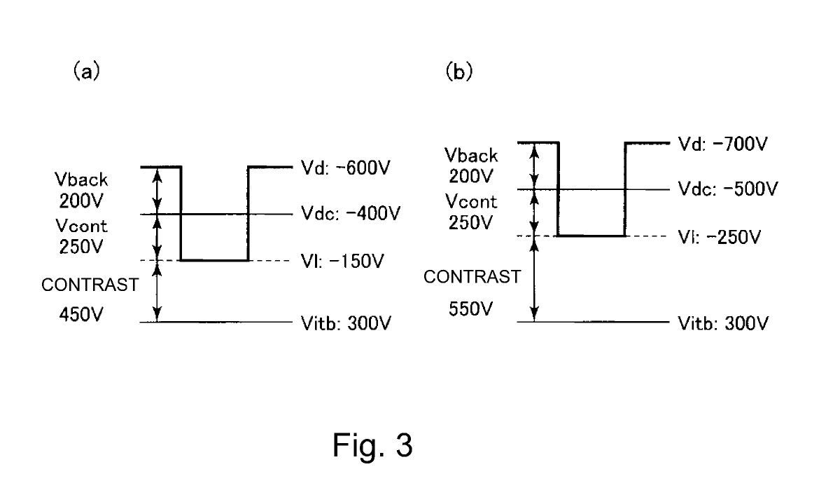

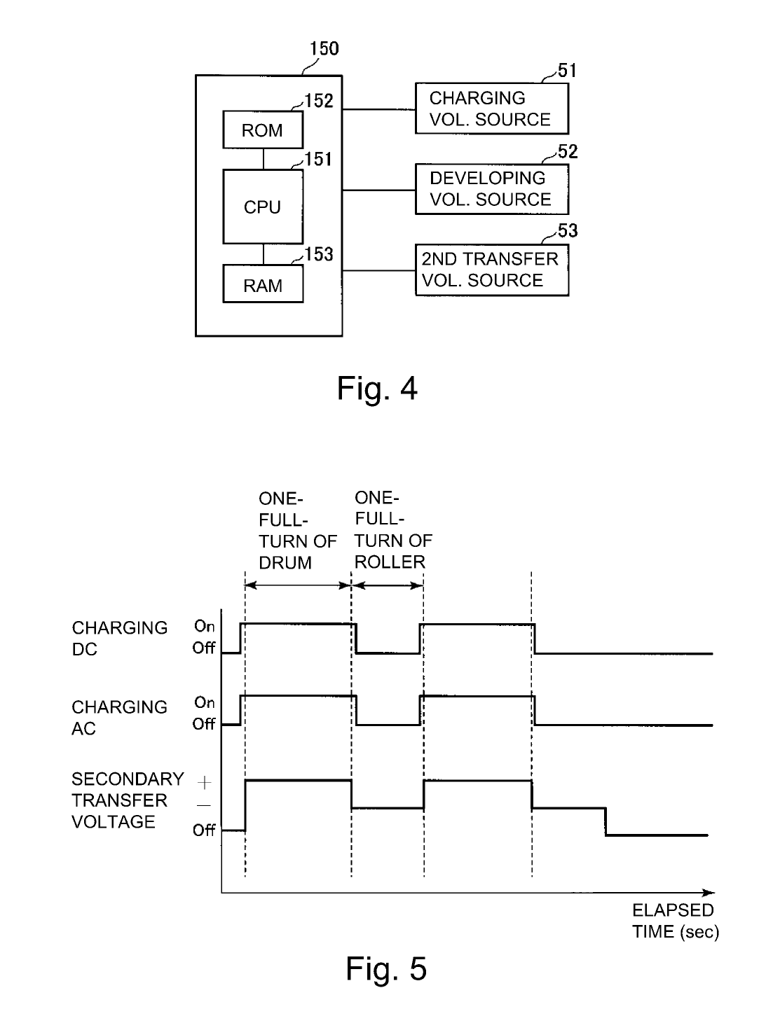

A surface of the rotating photosensitive drum 1 is electrically charged uniformly to a predetermined polarity (negative in this embodiment) and a predetermined potential by a charging roller 2 which is roller-shaped charging member as a charging means. At this time, to the charging roller 2, a predetermined charging voltage (charging bias) is applied from a charging voltage source (high-voltage source) 51 (FIG. 4) as a charging voltage applying means. In this embodiment, the charging voltage source 51 includes a DC outputting portion and an AC outputting portion and applies an oscillating voltage in the form of a DC voltage as a charging voltage biased with an AC voltage to the charging roller 2. The charging roller 2 is press-contacted to the surface of the photosensitive drum 1 with a predetermined pressing force (pressure).

The charged photosensitive drum 1 is exposed to light depending on image information by an exposure device (laser scanner device) 3 as an exposure means. The exposure device 3 outputs, from a laser outputting portion, laser light which is modulated correspondingly to a time-series electrical digital pixel signal of the image information inputted from a host computer (not shown). Then, the surface of the photosensitive drum 1 is subjected to scanning exposure via a reflection mirror or the like. As a result, on the photosensitive drum 1, an electrostatic latent image (electrostatic image) depending on the image information of a color component corresponding to the associated image forming portion S is formed.

The electrostatic latent image formed on the photosensitive drum 1 is developed (visualized) with a toner as a developer by a developing device 4 as a developing means. As a result, on the photosensitive drum 1, a toner image depending on image information of a color component corresponding to each of the image forming portions S. The developing device 4 includes a developing container for accommodating the toner, and a developing roller as a rotatable developer carrying member disposed at an opening of the developing container opposing the photosensitive drum 1. During the development, to the developing device 4, a predetermined developing voltage is applied from a developing voltage source (high voltage source) 52 (FIG. 4) as a developing voltage applying means. In this embodiment, the toner image is formed by image portion exposure and reverse development. That is, the developing device 4 deposits the toner charged to the same polarity as the charge polarity of the photosensitive drum 1 on an exposed portion of the photosensitive drum 1 lowered in absolute value of the potential by the exposure to light after the photosensitive drum 1 is uniformly charged. In this embodiment, the charge polarity (normal charge polarity) of the toner during the development is the negative polarity.

The toner image formed on the photosensitive drum 1 is transferred (primary-transferred) onto an intermediary transfer belt 7 in a process in which the toner image passes through a primary transfer portion (primary transfer nip) N1 which is a contact portion between the photosensitive drum 1 and the intermediary transfer belt 7 as a rotatable intermediary transfer member. For example, during full-color image formation steps of charging, exposure, development and primary transfer as described above are similarly performed at each of the first, second, third and fourth image forming portions Sa, Sb, Sc and Sd. Then, the toner images of the respective colors of Y, M, C and Bk are successively primary-transferred onto the intermediary transfer belt 7 in a superposition manner. As a result, on the intermediary transfer belt 7, a synthetic color image (multiple-toner images) corresponding to an objective color image can be obtained.

The toner image on the intermediary transfer belt 7 is transferred (secondary-transferred) onto a transfer material P in a process in which the toner image passes through a secondary transfer portion (secondary transfer nip) N2 which is a contact portion between the intermediary transfer belt 7 and a secondary transfer roller 13 which is a roller-shaped secondary transfer member as a secondary transfer means. At this time, to the secondary transfer roller 13, a predetermined secondary transfer voltage is applied from a secondary transfer voltage source (high-voltage source) 52 as a secondary transfer voltage applying means. For example, during the full-color image formation, the multiple-toner images formed on the intermediary transfer belt 7 are collectively secondary-transferred onto the transfer material P. The transfer material P such as a recording sheet (paper) is supplied to the secondary transfer portion N2 by being timed to the toner images on the intermediary transfer belt 7 by a transfer material feeding (supplying) roller (not shown) as a transfer material feeding (supplying) means.

The intermediary transfer belt 7, a primary transfer step and a secondary transfer step will be described specifically later.

The transfer material P on which the toner images are transferred is introduced into a fixing device (not shown) as a fixing means. The transfer material P is heated and pressed in a process in which the transfer material P is sandwiched and fed between a fixing roller and a pressing roller which press-contact each other in the fixing device, so that the toner on the transfer material P is melted and fixed. For example, during full-color image formation, the toner of the plurality of colors are melt-mixed and are fixed on the transfer material P. The transfer material P on which the toner image is fixed is discharged (outputted) to an outside of an apparatus main assembly of the image forming apparatus 100.

The toner (primary transfer residual toner) remaining on the surface of the photosensitive drum 1 after the primary transfer step is removed and collected by a cleaning device 6 as a cleaning means. The toner (secondary transfer residual toner) remaining on the surface of the intermediary transfer belt 7 after the secondary transfer step is removed and collected by a belt cleaning device 14.

### 2. Intermediary Transfer Belt

In this embodiment, the intermediary transfer belt 7 has a multi-layer structure in which an electric resistance of a surface layer is higher than an electric resistance of another layer. Specifically, the intermediary transfer belt 7 in this embodiment has a two-layer structure consisting of a base layer and the surface layer. As the base layer, a layer in which an antistatic agent such as carbon black is contained in a proper amount in a resin such as polyimide or polyamide or various rubbers is used. A volume resistivity of the base layer is 10²-10⁷ Ω·cm. A thickness of the base layer is about 45-100 μm, for example. The base layer is constituted by a film-like endless belt. The resin used for the base layer may also be polyphenylene sulfide (PPS), PVdF, nylon, PET, PBT, polycarbonate, PEEK, PEN and the like. On the base layer, as the surface layer, a coat layer which is substantially electrically insulative is provided. A thickness of the surface layer is 0.5-10 μm. A volume resistivity of the intermediary transfer belt 7 including the surface layer is 10¹⁰-10¹³ Ω·cm with respect to a thickness direction of the intermediary transfer belt 7.

The intermediary transfer belt 7 is stretched by a driving roller 10, a tension roller 11 and an idler roller 12 as a plurality of supporting members. The intermediary transfer belt 7 is circulated and driven (rotated) in an indicated by an arrow R2 direction at a predetermined peripheral speed (process speed) by transmitting a driving force thereto by the driving roller 10. In this embodiment, the process speed is 135 mm/sec. The driving roller also functions as an secondary transfer opposite roller (secondary transfer inner roller) and is driven by a motor excellent in constant-speed property, thus circulating and driving the intermediary transfer belt 7. The tension roller not only applies a certain tension to the intermediary transfer belt 7 but also functions as a correction roller for preventing oblique movement (meandering) of the intermediary transfer belt 7. The idler roller 12 forms an image transfer surface of the intermediary transfer belt 7 between itself and the tension roller 11. In this embodiment, the tension of the intermediary transfer belt 7 relative to the tension roller 11 is constituted so as to be about 5-12 kgf. As specifically described later, the toner images on the photosensitive drums 1a, 1b, 1c and 1d are successively attracted to the intermediary transfer belt 7 electrostatically, so that superposed toner images are formed on the intermediary transfer belt 7. The primary transfer portions N1 are constituted by contact portions (nips) between the intermediary transfer belt 7 subjected to tension and the photosensitive drums 1a, 1b, 1c and 1d. The secondary transfer portions N2 are constituted by contact portions (nips) between the intermediary transfer belt 7 and a secondary transfer roller (secondary transfer outer roller) 13 disposed opposed to the driving roller (secondary transfer inner roller) 10 in an outer peripheral surface (toner image carrying surface) side of the intermediary transfer belt 7.

The driving roller 10 includes a core metal (core material) and an electroconductive elastic layer (rubber layer) formed as a surface layer using EPDM rubber on the core metal so as to have an outer diameter of 20 mm and a thickness of 0.5 mm, and a hardness is set at 70° (Asker-C), for example. On the other hand, the secondary transfer roller 13 includes a core metal (core material) and an elastic layer formed using NBR rubber or EPDM rubber on the core metal so as to have an outer diameter of 20 mm. To the secondary transfer roller 13, a secondary transfer voltage source 53 is connected. A voltage applied from the secondary transfer voltage source 53 to the secondary transfer roller 13 is variable.

With respect to a rotational direction of the intermediary transfer belt 7, a belt cleaning device 14 for cleaning the surface of the intermediary transfer belt 7 is provided downstream of the secondary transfer portion N2 and upstream of the primary transfer portion N1a of the first image forming portion Sa. The belt cleaning device 14 removes a deposited matter such as the residual toner or paper powder on the intermediary transfer belt 7 after the secondary transfer step. In this embodiment, the belt cleaning device 14 is provided opposed to the tension roller 11.

### 3. Adjusting Method of Intermediary Transfer Belt Surface Potential

An adjusting method of a surface potential of the intermediary transfer belt 7 in this embodiment will be described.

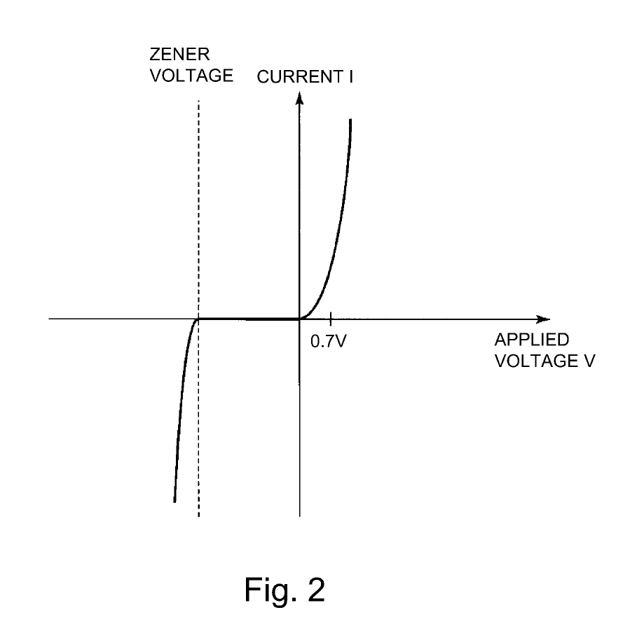

In this embodiment, all of the stretching rollers 10, 11 and 12 which support the intermediary transfer belt 7 are electrically grounded (connected to the ground) via a Zener diode 15 which is a constant-voltage element. FIG. 2 shows an electric characteristic (VI characteristic) of the Zener diode 15. The Zener diode 15 has such a VI characteristic that a current little flows until a voltage of not less than a Zener voltage but abruptly flows when the voltage exceeds a predetermined Zener voltage. In this embodiment, the surface potential of the intermediary transfer belt 7 is controlled at a certain level using the electric characteristic of the Zener diode 15. That is, the surface potential of the intermediary transfer belt 7 to be intended to be set is set at the Zener voltage and the secondary transfer voltage is controlled so that the surface potential of the intermediary transfer belt 7 exceeds the Zener voltage, whereby it becomes possible to always maintain the surface potential of the intermediary transfer belt 7 at a constant level. As a result, the surface potential of the intermediary transfer belt 7 can be maintained at a predetermined value or more so as to form a potential difference for permitting satisfactory primary transfer between the photosensitive drum 1 and the intermediary transfer belt 7.

In this embodiment, a plurality of Zener diodes each of 25 V in Zener voltage are connected in series, so that the surface potential of the intermediary transfer belt 7 was set at 300 V.

The surface potential of the intermediary transfer belt 7 is different depending on a combination of a species of the toner used and materials for the photosensitive drum 1 and the intermediary transfer belt 7, but may preferably be set at about 200 V to about 600 V. In this embodiment, all of the stretching rollers 10, 11 or 12 were grounded via a common Zener diode. However, some or all of the plurality of stretching rollers may also be grounded individually via the Zener diode or may also be grounded via the common Zener diode every plurality of stretching rollers. In order to stabilize the surface potential of the intermediary transfer belt 7 of an opposite polarity to that during image formation at the time such as when a cleaning operation described later, the above-described Zener diodes may also be connected in series and in opposite directions.

By the constitution described above, when the voltage is applied from the secondary transfer voltage source 53 to the secondary transfer roller 13, the current flows into the photosensitive drums 1a, 1b, 1c and 1d via the intermediary transfer belt 7. For that reason, an electric field action similar to the case where the voltage is applied to each of the primary transfer portions by a conventional voltage source exclusively for the primary transfer acts, so that it is possible to execute the primary transfer of from each of the photosensitive drums 1a, 1b, 1c and 1d onto the intermediary transfer belt 7. That is, in this embodiment, the current is caused to flow through the intermediary transfer belt 7 in a circumferential direction using the secondary transfer voltage source 53, whereby the intermediary transfer belt 7 is charged to a predetermined surface potential and thus a potential is generated at the primary transfer portion N1. Specifically, at the primary transfer portion N1, a predetermined potential of a positive polarity (opposite to the normal charge polarity of the toner) is generated on the intermediary transfer belt 7. The predetermined potential is higher in a positive polarity (opposite to the normal charge polarity of the toner) side relative to the potential of the photosensitive drum 1. As a result, by the action of the potential difference (electric field) formed between the intermediary transfer belt 7 and the photosensitive drum 1 at the primary transfer portion N1, the negatively charged toner on the photosensitive drum 1 is moved onto the intermediary transfer belt 7, so that the primary transfer is effected.

Further, a potential is generated at the secondary transfer portion N2 by applying a predetermined voltage from the secondary transfer voltage source 53 to the secondary transfer roller 13. Specifically, at the secondary transfer portion N2,the predetermined potential of the positive polarity (opposite to the normal charge polarity of the toner) is generated on the secondary transfer roller 13. The predetermined potential is high in a positive polarity (opposite to the normal charge polarity of the toner) side relative to the potential of the intermediary transfer belt 7. As a result, by the action of the potential difference (electric field) formed between the intermediary transfer belt 7 and the secondary transfer roller 13 at the secondary transfer portion N2, the negatively charged toner image on the intermediary transfer belt 7 is moved onto the transfer material P, so that the secondary transfer is effected.

### 4. Adjusting Method of Transfer Contrast

An adjusting method of a transfer contrast (primary transfer contrast) will be described. In FIG. 3, (a) is a schematic view showing a relationship between the surface potential of the photosensitive drum 1 and the surface potential of the intermediary transfer belt 7 in this embodiment.

In this embodiment, the surface potential of the photosensitive drum 1 is uniformly charged to a non-image portion potential (dark portion potential) Vd by the charging roller 2. In this embodiment, the non-image portion potential Vd is −600 V. The surface potential of the photosensitive drum 1 at an exposed portion is changed to an image portion potential (light portion potential) Vl by exposing the photosensitive drum 1 to light by the exposure device 3. In this embodiment, the exposed portion potential Vl is −150 V. Relative to the surface potential of the photosensitive drum 1, a developing bias Vdc (DC component of a developing voltage) is applied to the developing roller of the developing device 4. The negatively charged toner is deposited on the image portion of the photosensitive drum 1 by a developing contrast Vcont which is a difference between the developing bias Vdc and the exposed portion potential Vl on the photosensitive drum 1. The toner on the photosensitive drum 1 is returned from the non-image portion to the developing roller of the developing device 4 by a back contrast Vback which is a difference between the developing bias Vdc and the non-image portion potential Vd on the photosensitive drum 1. In this embodiment, the developing bias Vdc is −400 V, and the developing contrast Vcont is 250 V. The back contrast Vback is 200 V. A surface potential Vitb of the intermediary transfer belt 7 is fixed at a desired value by the Zener diode 15. For that reason, when the Zener voltage is set at 300 V, a transfer contrast which is a difference between the surface potential Vtib of the intermediary transfer belt 7 and the image portion potential Vl on the photosensitive drum 1 is 450 V.

In this embodiment, in the case where the transfer contrast is adjusted, as shown in (b) of FIG. 3, not the surface potential Vtib of the intermediary transfer belt 7, the surface potentials Vd and Vl of the photosensitive drum 1 are changed. However, in the case where the developing bias Vdc is changed, control in which Vd, Vdc and Vl are offset to the negative side is effected while fixing the developing contrast Vcont and the back contrast Vback.

Table 1 is an environment table of the transfer contrasts for the respective colors of Y, M, C and Bk.

TABLE 1

| ENV^{*1} | 1 | 2 | 3 | 4 | 5 | 6 | 7 |
|---|---|---|---|---|---|---|---|
| Y, M, C | 350 | 375 | 400 | 425 | 450 | 475 | 500 |
| Bk | 370 | 400 | 430 | 460 | 490 | 520 | 550 |

^{*1}“ENV” is an environment.

In this way, the environment table of the transfer contrast with respect to each of the image forming portions S is set in advance, and then switching control of the transfer contrast is effected depending on each environment (water content in this embodiment), so that it is possible to obtain a necessary transfer contrast for each of the environments and each of the colors. Further, with respect to a change in necessary transfer contrast due to repetitive use of, e.g., the developer in the developing device 4 and the intermediary transfer belt 7, it is possible to effect switching control of the environment table of the transfer contrast depending on, e.g., an image output sheet number as a value correlated with a use (operation) amount. As a result, it is possible to obtain the necessary transfer contrast also correspondingly to the change due to the repetitive use.

### 5. Control Mode

FIG. 4 is a block diagram showing a control mode of a principal part of the image forming apparatus 100 in this embodiment. In this embodiment, the controller 150 as a control means provided in the image forming apparatus 100 effects general control of the image forming apparatus 100. The controller 150 is constituted by including the CPU 151 which is a central element for performing computation and including ROM 152 and RAM 153, and so on. In the RAM 153, a sensor detection result, a computation result and the like are stored, and in the ROM 152, a control program, a data table obtained in advance, and the like are stored. With the controller 150, each of objects-to-be-controlled in the image forming apparatus 100 is connected. Particularly, in this embodiment, the charging voltage source 51, the developing voltage source 52 and the secondary transfer voltage source 53 and the like are connected with the controller 150. The controller 150 effects not only control of ON/OFF and output controller 150 effects integrated control of values of output of the charging voltage source 51, the developing voltage source 52 and the secondary transfer voltage source 53 during image formation but also control of ON/OFF and output values of output of the charging voltage source 51, the developing voltage source 52 and the secondary transfer voltage source 53 in a cleaning operation of the secondary transfer roller 13 described later.

Here, the image forming apparatus 100 performs a series of image forming operations (job) which is started by a start instruction (command) and in which an image is formed on a single or a plurality of transfer materials P and then the transfer materials P are outputted. The job generally includes an image forming step (printing step), a pre-rotation step, a sheet interval (transfer material interval) step in the case where the image is formed on the plurality of the transfer materials P, and a post-rotation step. The image forming step is a period in which formation of the electrostatic latent image for an image formed and outputted on the transfer material P, formation of the toner image, and primary transfer and secondary transfer of the toner image are actually performed, and “during image formation” refers to this period. The pre-rotation step is a period in which a preparatory operation, from input of the start instruction until the image formation is actually started, before the image forming step is performed. The sheet interval step is a period corresponding to an interval between a transfer material P and a subsequent transfer material P when the image forming step is continuously performed (continuous image formation) with respect to the plurality of transfer materials P. The post-rotation step is a period in which an arranging operation (preparatory operation) after the image forming step is performed. “During non-image formation” refers to a period other than “during image formation”, and includes the pre-rotation step, the sheet interval step, the post-rotation step and further includes a pre-multi-rotation step which is a preparatory operation during main switch actuation of the image forming apparatus 100 or during restoration from a sleep state.

### 6. Cleaning Operation of Secondary Transfer Roller

The cleaning operation (cleaning sequence) of the secondary transfer roller 13 will be described. FIG. 5 is a timing chart showing timing of application of the charging voltage and the secondary transfer voltage in the cleaning operation of the secondary transfer roller 13 in this embodiment.

As shown in FIG. 5, in this embodiment, in the cleaning operation, voltages of the positive polarity (opposite to the charge polarity of the photosensitive drum 1) and the negative polarity (identical to the charge polarity of the photosensitive drum 1) are alternately applied as the secondary transfer voltage. As a result, the positive polarity toner and the negative polarity toner which are deposited on the secondary transfer roller 13 are transferred onto the intermediary transfer belt 7 by application of the positive polarity voltage and the negative polarity voltage, respectively. The toner transferred on the intermediary transfer belt 7 is collected by the belt cleaning device 14.

In this embodiment, in the cleaning operation. in the case where the secondary transfer voltage of the positive polarity (opposite to the charge polarity of the photosensitive drum 1) is applied, an application time of one cleaning operation is set to a time which is a substantially integer multiple of a time required for one full turn of the photosensitive drum 1. That is, the application time is set to a time required for movement of the surface of the photosensitive drum 1 by a distance corresponding to a substantially integer multiple of a circumferential length (peripheral length) of the photosensitive drum 1. Particularly, in this embodiment, this time was set to a time corresponding to one full turn of the photosensitive drum 1. This time is not limited thereto, but from the viewpoint of shortening a time required for the cleaning operation or the like, this time may preferably be set to a time corresponding to 5 full turns or less, typically one full turn of the photosensitive drum 1.

On the other hand, in the cleaning operation, in the case where the secondary transfer voltage of the negative polarity is applied, an application time of one cleaning operation is set to a time which is a substantially integer multiple of a time required for one full turn of the secondary transfer roller 13. That is, the application time is set to a time required for movement of the surface of the secondary transfer roller 13 by a distance corresponding to a substantially integer multiple of a circumferential length (peripheral length) of the secondary transfer roller 13. Particularly, in this embodiment, this time was set to a time corresponding to one full turn of the secondary transfer roller 13. This time is not limited thereto, but from the viewpoint of shortening a time required for the cleaning operation or the like, this time may preferably be set to a time corresponding to 5 full turns or less, typically one full turn of the secondary transfer roller 13.

Incidentally, the “substantially integer multiple” includes not only the case of a complete integer multiple but also the case where a value is deviated from the integer multiple within an allowable error range. For example, in some cases, an error of about ±20% is allowed.

In this embodiment, in the cleaning operation, only in the case where the secondary transfer voltage of the positive polarity is applied, the charging voltage is applied in synchronism with the application of the secondary transfer voltage of the positive polarity, so that the photosensitive drum 1 is charged to the negative polarity. Here, the synchronization of the application of the charging voltage with the application of the secondary transfer voltage of the positive polarity means that the charging voltage is applied at timing when a region of the photosensitive drum 1 contacting the intermediary transfer belt 7 charged to the positive polarity by application of at least the secondary transfer voltage of the positive polarity is charged. As shown in FIG. 5, in this embodiment, the application of the charging voltage is started before start of the application of the secondary transfer voltage of the positive polarity (before not less than a time required for movement of the surface of the photosensitive drum 1 from a charging portion by the charging roller 2 to the primary transfer portion N1). In this embodiment, in order that the region of the photosensitive drum 1 contacting the intermediary transfer belt 7 charged to the positive polarity can be charged with reliability, the application of the charging voltage is stopped after the application of the secondary transfer voltage of the positive polarity is ended (i.e., after the secondary transfer voltage of the negative polarity is applied or the application thereof is turned off). Incidentally, in the case where a sufficiently charged region of the photosensitive drum 1 can reach the primary transfer portion N1 during a time from the start of application of the secondary transfer voltage until the intermediary transfer belt 7 is sufficiently charged, the application start of the secondary transfer voltage and the application start of the charging voltage may also be made substantially simultaneously. Further, in the case where the intermediary transfer belt 7 can be sufficiently discharged during a period from stop of the application of the charging voltage until an uncharged region of the photosensitive drum 1 reaches the primary transfer portion N1, the application start of the secondary transfer voltage and the application start of the charging voltage may also be made substantially simultaneously. On the other hand, in the case where the secondary transfer voltage of the negative polarity is applied, in order to cause the current to flow from the secondary transfer roller 13 into the photosensitive drum 1, the application of the charging voltage is not effected, so that the photosensitive drum 1 is not charged.

The cleaning operation can be executed at arbitrary timing during non-image formation. For example, every predetermined image output sheet number, the cleaning operation can be executed in the pre-rotation step, the post-rotation step, the sheet interval step or the like. In addition, the cleaning operation may also be executed in a restoring operation (restoring sequence) after jam clearance.

Next, the reason why in the case where the secondary transfer voltage of the positive polarity is applied in the cleaning operation, the application time is set to the time corresponding to a substantially integer multiple of the circumferential length of the photosensitive drum 1 will be described. In this embodiment, the photosensitive drum 1 of 30 mm in diameter and the secondary transfer roller 13 of 20 mm in diameter were used. That is, the circumferential length of the secondary transfer roller 13 is smaller than the circumferential length of the photosensitive drum 1. When the application time of the secondary transfer voltage of the positive polarity is set to the time corresponding to non-integer multiple of the circumferential length of the photosensitive drum 1, in the case where an excessive current flows into the primary transfer portion N1, with respect to a sub-scanning direction of the photosensitive drum 1, a region which comes under the influence of a discharge current and a region which does not come under the influence of the discharge current generate. For example, there is the case where the application time of the secondary transfer voltage of the positive polarity is set to the time corresponding to the integer multiple of the circumferential length of the secondary transfer roller 13. As a result, when the photosensitive drum 1 is charged during subsequent image formation, a potential corresponding to the one full turn of the photosensitive drum 1 with respect to the sub-scanning direction varies, so that potential non-uniformity generates and thus there is a liability that local image density non-uniformity (drum memory) generates.

On the other hand, as in this embodiment, when the application time of the secondary transfer voltage of the positive polarity is set to the time corresponding to substantially integer multiple of the circumferential length of the photosensitive drum 1, even when the excessive current flows into the primary transfer portion N1, a portion of the photosensitive drum 1 corresponding to one full turn of the photosensitive drum 1 with respect to the sub-scanning direction uniformly comes under the influence of the discharge current. For this reason, when the photosensitive drum 1 is charged during subsequent image formation, the potential corresponding to the one full turn of the photosensitive drum 1 with respect to the sub-scanning direction is uniformly deviated from the normal potential, so that the local image density non-uniformity does not readily generates.

As described above, in the case where the photosensitive drum 1 is not charged when the secondary transfer voltage is applied, the surface potential of the photosensitive drum 1 after passing through the primary transfer portion N1 is reversed in polarity to the opposite polarity to the charge polarity, so that the drum memory is liable to generate. In this embodiment, a constitution in which the drum memory is made less conspicuous by adjusting the application time of the secondary transfer voltage of the positive polarity as described above is employed, but it is desirable that the influence of the discharge current on the photosensitive drum 1 is minimized. Accordingly, in this embodiment, in the cleaning operation, when the secondary transfer voltage of the positive polarity is applied, the charging voltage is applied in a synchronism manner in order to cause the current to flow from the secondary transfer roller 13 into the photosensitive drum 1, so that the photosensitive drum 1 is charged to the negative polarity. In this embodiment, as the charging voltage at this time, a superposed voltage, of the AC component and the DC component, which is the same as that during image formation is applied. However, the charging voltage at this time is different from the charging voltage during image formation and is not necessarily required to provide charging uniformity of the photosensitive drum 1, and therefore the AC voltage superposed for improving the charging uniformity is not applied but only the DC voltage may also be applied. It is not necessarily required that the photosensitive drum 1 is charged to the charge potential similar to that during image formation, and therefore a DC voltage smaller in absolute value than that during image formation may also be applied. In the present invention, the application of the charging voltage at this time is not essential.

On the other hand, when the secondary transfer voltage is applied, the intermediary transfer belt 7 is charged to the same polarity as the charge polarity of the photosensitive drum 1. For that reason, even in a state in which the photosensitive drum 1 is not charged, the photosensitive drum 1 does not readily or substantially comes under the influence of the discharge current due to the flow of the excessive current as described above. For that reason, from the viewpoint of shortening the time required for the cleaning operation or the like, when the secondary transfer voltage of the negative polarity is applied, the application time is set to the time, corresponding to the integer multiple of the circumferential length of the secondary transfer roller 13, desired in order to uniformly clean the secondary transfer roller 13 with respect to the circumferential direction. When the secondary transfer voltage of the negative polarity is applied, the charging voltage is not applied.

In this embodiment, in a single cleaning operation, the voltages of the positive polarity and the negative polarity were alternately applied to the secondary transfer roller 13, but the present invention is not limited thereto. For example, in the single cleaning operation, the positive polarity voltage may also be applied to the secondary transfer roller 13. In this case, in the single cleaning operation performed at another timing, the negative polarity voltage is applied to the secondary transfer roller 13. Further, in the cleaning operation, the positive polarity voltage may also be intermittently applied to the secondary transfer roller 13. In the cleaning operation, a plurality of positive polarity voltages different in value may also be applied to the secondary transfer roller 13. In this embodiment, in the case where at least the positive polarity voltage is applied to the secondary transfer roller 13 in the cleaning operation, a continuous application time of a positive polarity voltage having a value may only be required to be set to a time corresponding to a substantially integer multiple of the circumferential length of the photosensitive drum 1. In the case where the plurality of the positive polarity voltages having different values are continuously applied, also a sum of application times of the positive polarity voltages is the time corresponding to the substantially integer multiple of the circumferential length of the photosensitive drum 1.

### 7. Evaluation Experiment Embodiment

A result of evaluation of an effect of the control in this embodiment will be described.

### 7-1. Evaluation Experiment 1

The application time of the secondary transfer voltage of the positive polarity in the cleaning operation was set to a time corresponding to a non-integer multiple of (one full turn of the secondary transfer roller 13 in this case) the circumferential length of the photosensitive drum 1. The current (set current) caused to flow through the secondary transfer portion N2 during image formation and during cleaning operation was set at 40 μA. The surface potential Vd of the photosensitive drum 1 and the surface potential Vitb of the intermediary transfer belt 7 were set so that a value of a current when the current is caused to flow through the primary transfer portion N1 was 10 μA. Then, in an NN environment (23° C., 50% RH), a continuous image output of an image having a print ratio of 5% was performed. During the continuous image output, the cleaning operation of the secondary transfer roller 13 was executed every predetermined image output number of sheets.

As a result, the image density non-uniformity due to the drum memory generated at about 10 k-th sheet on an A4 basis.

### 7-2. Evaluation Experiment 2

In accordance with this embodiment, the application time of the secondary transfer voltage of the positive polarity in the cleaning operation was set to the time corresponding to the substantially integer multiple (one full turn of the photosensitive drum 1 in this embodiment) of the circumferential length of the photosensitive drum 1. Other conditions are the same as those in Evaluation experiment 1.

As a result, even at about 10 k-th sheet on the A4 basis, the image density non-uniformity due to the drum memory did not generate. The experiment was conducted also in the case where the charging voltage was not applied when the secondary transfer voltage of the positive polarity was applied, local image density non-uniformity generated in some cases, but was at such a level that a degree thereof was practically of no problem.

As described above, the image forming apparatus 100 in this embodiment includes the plurality of the photosensitive drums 1 which are rotatable and which carry the toner images and the plurality of the charging rollers 2 for electrically charging the photosensitive drums 1, respectively, to the first polarity. The image forming apparatus 100 includes the intermediary transfer belt 7, rotatable in contact with the photosensitive drums 1 while being stretched by the plurality of the supporting members 10, 11 and 12, for secondary-transferring the toner images, primary-transferred from the photosensitive drums 1, onto the transfer material P. The image forming apparatus 100 includes the transfer member 13 contacting the intermediary transfer belt 7 and the voltage source 53 for secondary-transferring the toner images from the intermediary transfer belt 7 onto the transfer material P by applying the voltage to the transfer member 13. The plurality of supporting members are connected with a constant-voltage element or a resistance element, and the voltage of the second polarity opposite to the first polarity is applied from the voltage source 53 to the transfer member 13, so that the surface potential of the intermediary transfer belt 7 is changed to the potential of the second polarity. As a result, the current flows from the transfer member 13 into the photosensitive drum 1 via the intermediary transfer belt 7, so that the toner image is primary-transferred from the photosensitive drum 1 onto the intermediary transfer belt 7. The image forming apparatus 100 includes the controller 150 for executing an adjusting operation for applying at least the voltage of the second polarity during non-image formation in which the primary transfer and the secondary transfer are not effected. The controller 150 sets the continuous application time, of the voltage having a certain value and the second polarity from the voltage source 53 to the transfer member 13, to the time which is the integer multiple of the time required for one full turn of the photosensitive drum 1. In this embodiment, in the adjusting operation, the controller 150 causes the charging means 2 to charge, to the first polarity, the region of the photosensitive drum 1 contacting the intermediary transfer belt 7 when the surface potential of the intermediary transfer belt 7 is changed to the potential of the second polarity under application of the voltage of the second polarity. Particularly, in this embodiment, the adjusting operation is such an operation that the deposited matter is transferred from the transfer member 13 onto the intermediary transfer belt 7 by alternately applying the voltages of the first polarity and the second polarity from the voltage source 53 to the transfer member 13. In this embodiment, the transfer member 13 is rotatable, and the circumferential length of the transfer member 13 is smaller than the circumferential length of the photosensitive drum 1. In the adjusting operation, the controller 150 sets the continuous application time, of the voltage which is applied from the voltage source 53 to the transfer member 13 and which has the certain value and the first polarity, to the time which is the integer multiple of the time required for one full turn of the transfer member 13.

As described above, in this embodiment, in the case where the secondary transfer voltage of the positive polarity is applied to the secondary transfer roller 13 in the cleaning operation as the adjusting operation performed during non-image formation, the application time thereof is set to the time corresponding to the integer multiple of the circumferential length of the photosensitive drum 1. Accordingly, it becomes possible to suppress an excessive cost and a downtime, e.g., in the case where the photosensitive drum 1 is exchanged when the drum memory generates. In this way, according to this embodiment, in the constitution in which the primary transfer is effected by causing the current to flow into the photosensitive member through the intermediary transfer belt under application of the secondary transfer voltage, it is possible to suppress the generation of the potential non-uniformity of the photosensitive member caused by the influence of the voltage applied to the secondary transfer portion in the adjusting operation.

### Embodiment 2

Next, another embodiment of the present invention will be described. Basic constitutions and operations of an image forming apparatus in this embodiment are the same as those in Embodiment 1. Accordingly, in the image forming apparatus in this embodiment, elements having the same or corresponding functions and constitutions as those in the image forming apparatus in Embodiment 1 are represented by the same reference numerals or symbols and will be omitted from detailed description.

### 1. Summary

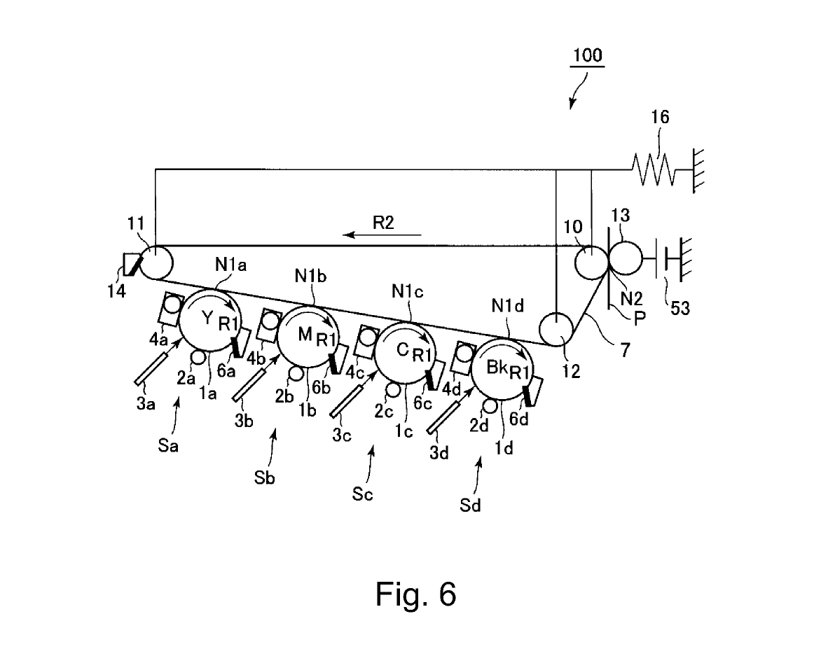

FIG. 6 is a schematic sectional view of the image forming apparatus 100 in this embodiment. In Embodiment 1, all of the stretching rollers 10, 11 and 12 were grounded via the Zener diode 15. On the other hand, in this embodiment, as shown in FIG. 6, all of the stretching rollers 10, 11 and 12 are grounded via a resistance element 16, in place of the Zener diode 15.

A resistance value of the resistance element 16 can be appropriately set so that the surface potential of the intermediary transfer belt 7 can be maintained at not less than a predetermined potential necessary to satisfactorily effect the primary transfer. This resistance value may preferably be 108Ω or more. This is because an impedance of the primary transfer portion where a conventional sponge roller or the like is used as the primary transfer member is on the order of 107Ω, and the current flowing into the stretching rollers is made small by using a resistor having a resistance sufficiently larger than the impedance and thus most of the current can be caused to flow into the photosensitive drum 1. In general, this resistance value is sufficient when the value is 109Ω or less. On the other hand, even when the resistance value is made small to about 100 MΩ, the primary transfer can be effected, but when the resistance value is made excessively small, there is a need to correspondingly increase a capacity of the voltage source. Accordingly, the resistance value may preferably be 108Ω or more and 109Ω or less. In this embodiment, a resistance value of the resistance element 16 was 108Ω.

In the case where a constitution using the resistance element is used, the surface potential of the intermediary transfer belt 7 fluctuates depending on the voltage applied to the secondary transfer roller 13. Accordingly, as an absolute value of the voltage applied to the secondary transfer roller 13 becomes larger, also the current flowing at the primary transfer portion N1 becomes larger. For that reason, in the case where a plurality of different voltages are applied to the secondary transfer roller 13 in the adjusting operation, when the absolute value of the secondary transfer voltage becomes excessively large, the current excessively flows through the primary transfer portion N1, there is a liability that the drum memory generates on the photosensitive drum 1.

In this embodiment, in ATVC control at the secondary transfer portion N2, in the case where a plurality of voltages of the positive polarity (opposite to the charge polarity of the photosensitive drum 1) are applied to the secondary transfer roller 13, an application time of each of the voltages is set to a time which is a substantially integer multiple of a time required for one full turn of the photosensitive drum 1. That is, the application time is set to a time required for movement of the surface of the photosensitive drum 1 by a distance corresponding to a substantially integer multiple of a circumferential length (peripheral length) of the photosensitive drum 1. Particularly, in this embodiment, this time was set to a time corresponding to one full turn of the photosensitive drum 1. This time is not limited thereto, but from the viewpoint of shortening a time required for the cleaning operation or the like, this time may preferably be set to a time corresponding to 5 full turns or less, typically one full turn of the photosensitive drum 1. In this way, in this embodiment, the adjusting operation is such an operation that the plurality of second polarity voltages having different values are applied from the voltage source 53 to the transfer member 13 and then a voltage applied from the voltage source 53 to the transfer member 13 during secondary transfer is obtained from a relationship between an applied voltage value and a value of a current which flowed.

### 2. ATVC Control at Secondary Transfer Portion

Next, ATVC (active transfer voltage control) at the secondary transfer portion N2 (hereinafter also referred to as secondary transfer ATVC) will be described. The secondary transfer ATVC is roughly the following control. For example, in the pre-rotation step, when there is no transfer material P at the secondary transfer portion N, the voltage is applied from the secondary transfer voltage source 53 to the secondary transfer roller 13, and information on the voltage value and the current value at that time are obtained. Then, on the basis of the information, a target value of the secondary transfer voltage to be applied from the secondary transfer voltage source 53 to the secondary transfer roller 13 during the image formation is obtained.

Specifically, in the secondary transfer ATVC, the target voltage value of the secondary transfer voltage during the image formation can be obtained in the following manner. For example, a generated voltage value when a voltage subjected to constant-current control at a predetermined target current value is applied from the secondary transfer voltage source 53 to the secondary transfer roller 13 is obtained. Then, the generated voltage itself or a value induced using a predetermined computing equation or look-up table set in advance on the basis of the value of the generated voltage can be used as the target voltage value of the secondary transfer voltage during the image formation. Or, the voltage applied from the secondary transfer voltage source 53 to the secondary transfer roller 13 is changed to a plurality of different voltages, and then a relationship between the voltage value and the current value is obtained. Then, on the basis of the relationship, a voltage value necessary to obtain a desired transfer current value is obtained and can be used as the target voltage value of the secondary transfer voltage during the image formation. In this embodiment, a latter method is employed as described hereinafter in detail.

The secondary transfer ATVC can be effected in the pre-rotation step in order to determine the target voltage value of the secondary transfer voltage during the image formation in the job. However, the method of the transfer voltage control is not limited thereto, but the secondary transfer ATVC can be effected in the pre-rotation step every job of plural times. Further, the timing of the secondary transfer ATVC is not limited to the pre-rotation step, but the transfer voltage control can also be effected at appropriate timing if the timing is during the non-image formation such as the sheet-interval step or the post-rotation step.

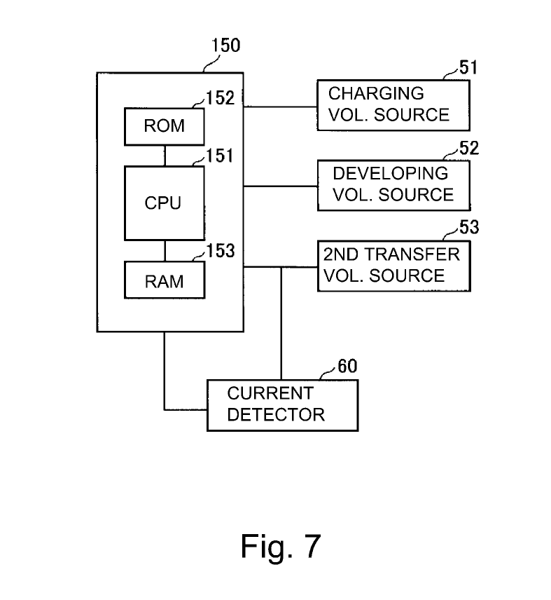

FIG. 7 is a block diagram showing a control mode of a principal part of the image forming apparatus 100 in this embodiment. The block diagram of FIG. 7 is roughly similar to the block diagram of FIG. 4, but in this embodiment, a current detecting circuit 60 as a current detecting means is further connected with the controller 150. In this embodiment, the current detecting circuit 60 is provided between the secondary transfer voltage source 53 and the secondary transfer roller 13.

As a result, the current detecting circuit 60 can detect a value of a DC current flowing through the secondary transfer roller 13 when the secondary transfer voltage source 53 applies the DC voltage to the secondary transfer roller 13. In this embodiment, the secondary transfer voltage source 53 is constituted so that it can output a constant voltage having a voltage value set by control of the controller 150. The controller 150 changes a set value of the output of the secondary transfer voltage source 53 so that the current value detected by the current detecting circuit 60 is a predetermined value, whereby a voltage supplying a predetermined current can be applied from the secondary transfer voltage source 53 to the secondary transfer roller 13. The controller 150 can obtain pieces of information on the voltage value and the current value from the set value of the output of the secondary transfer voltage source 53 and a detection result of the current detecting circuit 60 at this time, respectively.

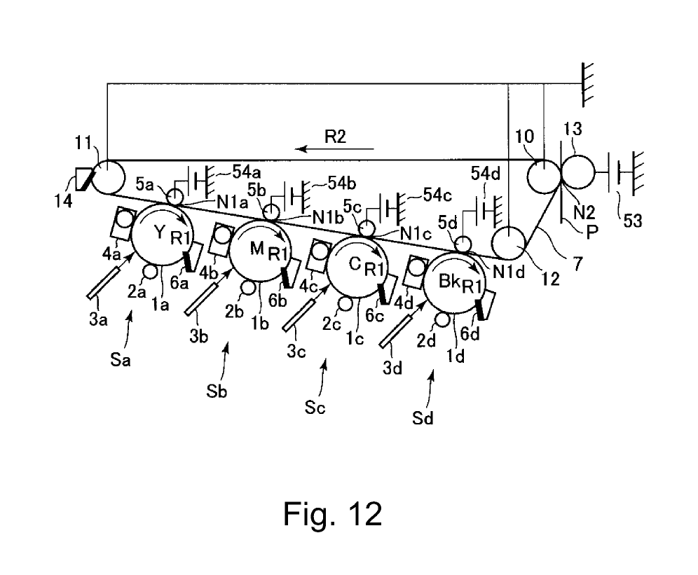

Here, secondary transfer ATVC in the conventional image forming apparatus including the voltage source exclusively for the primary transfer and the voltage source exclusively for the secondary transfer will be described. FIG. 11 is a timing chart showing application timing of the charging voltage and the secondary transfer voltage in the secondary transfer ATVC in the conventional image forming apparatus. FIG. 12 is a schematic sectional view of the conventional image forming apparatus including the voltage source exclusively for the primary transfer. In FIG. 12, elements having the same or corresponding functions or constitutions as those for the image forming apparatus 100 shown in FIG. 6 in this embodiment are represented by the same reference numerals or symbols. In the image forming apparatus 100 shown in FIG. 12, the primary transfer roller 5 is disposed in the inner peripheral surface side of the intermediary transfer belt 7 so as to oppose the photosensitive drum 1 at each of the image forming portions. The transfer roller 5 is urged toward the photosensitive drum 1 via the intermediary transfer belt 7, so that the primary transfer portion N1 is formed at the contact portion between the photosensitive drum 1 and the intermediary transfer belt 7. To each of the transfer rollers 5, a primary transfer voltage source 54 exclusively for the primary transfer is independently connected, and to the secondary transfer roller 13, the secondary transfer voltage source 53 exclusively for the secondary transfer is connected. All of the stretching rollers 10, 11 and 12 for the intermediary transfer belt 7 are grounded.

As shown in FIG. 12, in the conventional image forming apparatus 100, the secondary transfer voltage is applied to the secondary transfer roller 13, so that the current is caused to flow through a grounded opposite member (detect transfer opposite roller). For that reason, even when the secondary transfer voltage is applied, the secondary transfer voltage does not have the influence on the primary transfer portion N1, and therefore the secondary transfer ATVC can be considered independently of the primary transfer portion N1.

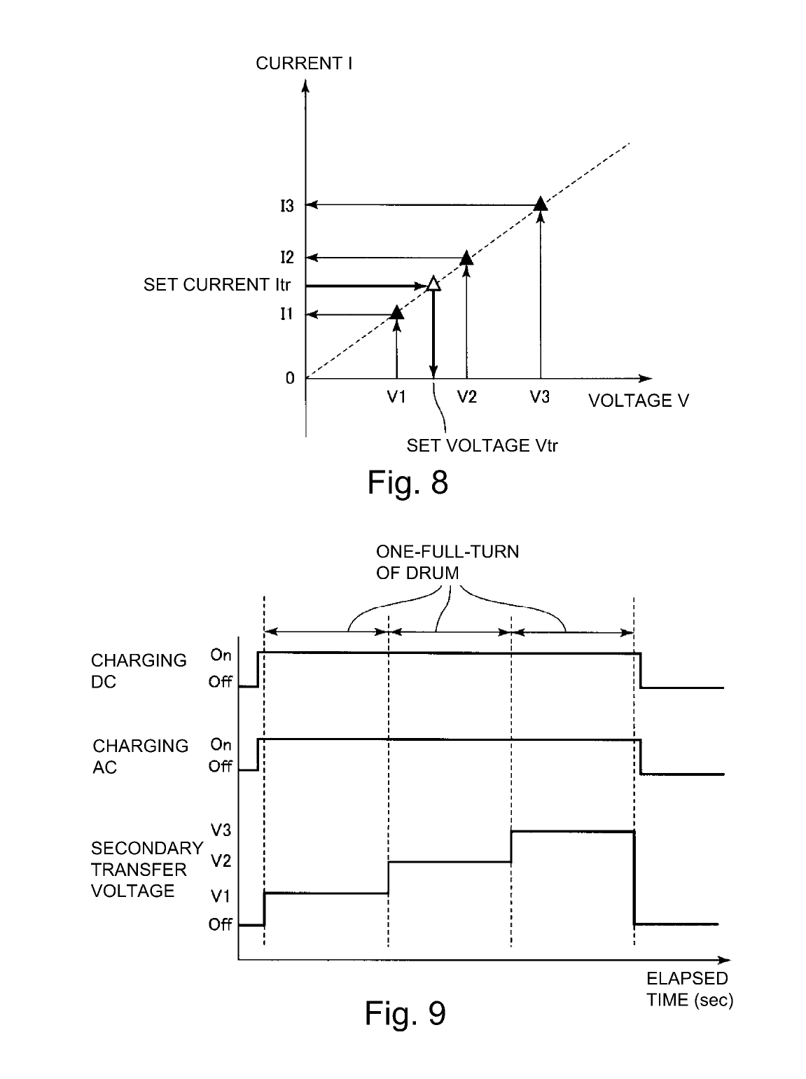

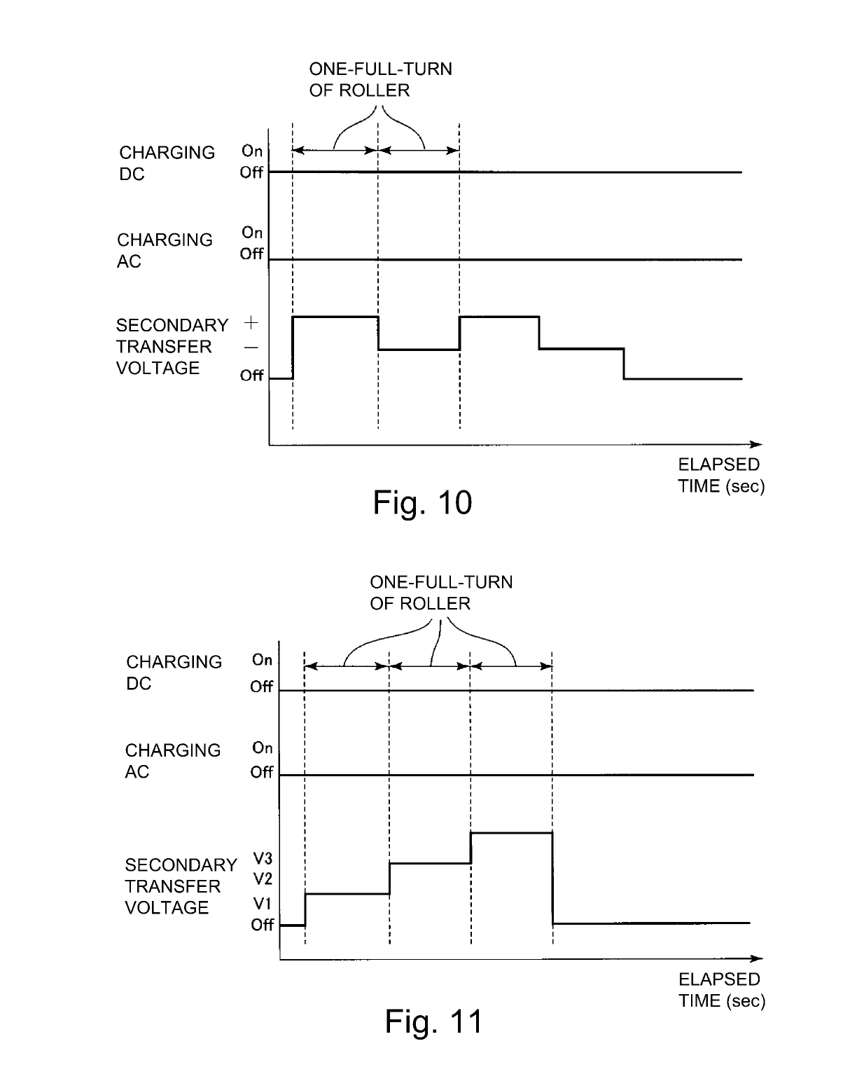

FIG. 8 is a graph for illustrating an operation for obtaining the secondary transfer voltage from the voltage value and the current value in the secondary transfer ATVC. As shown in FIG. 8, in the secondary transfer ATVC, a plurality of different voltages V1, V2 and V3 of the positive polarity are applied, and then currents I1, U2 and I3 flowing at that time are detected. Then, from a relationship between the voltage value and the current value which are obtained, a set voltage Vtr relative to a set current Itr is determined.

Here, as shown in FIG. 11, in the conventional image forming apparatus 100, the voltage application time to the secondary transfer roller 13 in the secondary transfer ATVC is set to a time corresponding to an integer multiple of the circumferential length of the secondary transfer roller 13 in consideration of electric resistance non-uniformity of the secondary transfer roller 13 in general. Further, in the secondary transfer ATVC, there is no need to synchronize the voltage application to the secondary transfer roller 13 with the charging voltage application.

Then, the secondary transfer ATVC in this embodiment will be described. FIG. 9 is a timing chart showing application timing of the charging voltage and the secondary transfer voltage in the secondary transfer ATVC in the image forming apparatus 100 in this embodiment.

In this embodiment, as shown in FIG. 9, in the secondary transfer ATVC, a plurality of different secondary transfer voltages of the positive polarity are applied to the secondary transfer roller 13. Then, an application time for each of the voltages is set to a time which is a substantially integer multiple of a time required for one full turn of the photosensitive drum 1. That is, the application time is set to a time required for movement of the surface of the photosensitive drum 1 by a distance corresponding to a substantially integer multiple of the circumferential length of the photosensitive drum 1. Particularly, in this embodiment, this time was set to a time corresponding to one full turn of the photosensitive drum 1. Similarly as in Embodiment 1, this time is not limited thereto.

In this embodiment, in the secondary transfer ATVC, when the secondary transfer voltage of the positive polarity is applied, the charging voltage is applied in a synchronism manner in order to cause the current to flow from the secondary transfer roller 13 into the photosensitive drum 1, so that the photosensitive drum 1 is charged to the negative polarity. In this embodiment, as the charging voltage at this time, a superposed voltage, of the AC component and the DC component, which is the same as that during image formation is applied. However, similarly as in Embodiment 1, the charging voltage at this time may also be only the DC voltage. In the present invention, the application of the charging voltage at this time is not essential.

In this embodiment, by the control as described above, a region of the photosensitive drum 1 corresponding to one full circumference of the photosensitive drum 1 with respect to the sub-scanning direction comes under the influence of the electric discharge uniformly even when the primary transfer current excessively flows. As a result, during subsequent image formation, the region corresponding to one full circumference of the photosensitive drum 1 with respect to the sub-scanning direction uniformly comes under the influence of the discharge current, and therefore local image density non-uniformity does not readily generates.

As described above, in this embodiment, in the case where the plurality of different secondary transfer voltages of the positive polarity are applied to the secondary transfer roller 13 in the secondary transfer ATVC as the adjusting operation performed during non-image formation, the application time thereof is set to the time corresponding to the integer multiple of the circumferential length of the photosensitive drum 1. Accordingly, it becomes possible to suppress an excessive cost and a downtime, e.g., in the case where the photosensitive drum 1 is exchanged when the drum memory generates.

### Other Embodiments

The present invention was described based on the specific embodiments mentioned above, but is not limited to the above-mentioned embodiments.

For example, in Embodiment 1, in place of the Zener diode, the resistance element described in Embodiment 2 may also be used.

The secondary transfer member was described as the roller-shaped member, but is not limited thereto. The secondary transfer member may also be members having a fixed brush shape, a sheet shape, a pad shape and so on.

The photosensitive member was described as the drum-shaped member, but is not limited thereto. The photosensitive member may also be an endless belt-shaped member.

As the constant-voltage element, in place of the Zener diode in the above-described embodiments, a varistor may also be used.

In the above-described embodiments, the transfer voltage was subjected to the constant-voltage control and the voltage value capable of providing a desired current value was obtained during non-image formation. However, the present invention is not limited thereto. For example, in the case where the transfer voltage is subjected to the constant-current control, a current value capable of providing a desired voltage value may also be obtained.

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Application No. 2014-225646 filed on Nov. 5, 2014, which is hereby incorporated by reference herein in its entirety.

What is claimed is:

1. An image forming apparatus comprising:
a photosensitive member for carrying a toner image;
a charging member for electrically charging said photosensitive member to a first polarity;
an intermediary transfer belt for carrying the toner image transferred from said photosensitive member at a first transfer position;
a transfer member, provided so as to be contactable to an outer peripheral surface of said intermediary transfer belt, for transferring the toner image from said intermediary transfer belt onto a recording material at a secondary transfer position;
a constant-voltage element, electrically connected between said intermediary transfer belt and a ground potential, for maintaining a predetermined voltage by a flow of a current therethrough;
a voltage source for applying a voltage of a second polarity opposite to the first polarity to said transfer member so as to form a secondary transfer electric field at the secondary transfer position and a primary transfer electric field at the primary transfer position; and
a controller for executing an adjusting operation for applying at least the voltage of the second polarity from said voltage source to said transfer member during non-image formation in which both of primary transfer and secondary transfer are not effected, wherein when the voltage of the second polarity is applied from said voltage source to said transfer member in the adjusting operation, said controller continuously applies the voltage for a time corresponding to a substantially integer multiple of a time required for one full turn of said photosensitive member.

2. An image forming apparatus according to claim 1, wherein in the adjusting operation, said controller electrically charges a region of said photosensitive member, contacting said intermediary transfer belt when the voltage of the second polarity is applied from said voltage source to said transfer member, to the first polarity in advance by said charging member.

3. An image forming apparatus according to claim 1, wherein said intermediary transfer belt has a multi-layer structure in which an electric resistance of a surface layer is higher than an electric resistance of another layer.

4. An image forming apparatus according to claim 1, wherein said constant-voltage element is Zener diode.

5. An image forming apparatus according to claim 1, wherein in the adjusting operation, said controller alternately applies a voltage of the first polarity and the voltage of the second polarity from said voltage source to said transfer member to transfer a deposited matter from said transfer member onto said intermediary transfer belt.

6. An image forming apparatus according to claim 1, wherein said transfer member is a transfer roller having a circumferential length shorter than a circumferential length of said photosensitive member, and
wherein in the adjusting operation, said controller sets a continuous application time of the voltage of the first polarity applied from said voltage source to said transfer member so as to be a substantially integer multiple of a time required for one full turn of said transfer roller.

7. An image forming apparatus according to claim 1, wherein in the adjusting operation, said controller obtains a voltage applied from said voltage source to said transfer member from a relationship between a value of an applied voltage and a value of a flowing current when a plurality of voltages having different values and the second polarity are applied from said voltage source to said transfer member.
